(19) United States
(12) Patent Application Publication
(10) Pub. No.: US 2026/0242653 A1
(43) Pub. Date: Aug. 20, 2026

(54) USE OF RARE EARTH BORATES IN MAGNETIC REFRIGERATION MATERIALS AND PREPARATION METHOD OF RARE EARTH BORATES

(71) Applicant: Ganjiang Innovation Academy, Chinese Academy of Sciences, Ganzhou, Jiangxi (CN)

(72) Inventors: Zhaojun Mo, Ganzhou, Jiangxi (CN); Huicai Xie, Ganzhou, Jiangxi (CN); Jun Shen, Ganzhou, Jiangxi (CN); Quanyi Liu, Ganzhou, Jiangxi (CN); Yuanpeng Wang, Ganzhou, Jiangxi (CN)

(21) Appl. No.: 19/009,920

(22) Filed: Jan. 4, 2025

Related U.S. Application Data
(63) Continuation-in-part of application No. PCT/CN2024/070517, filed on Jan. 4, 2024.

(30) Foreign Application Priority Data
Mar. 14, 2023 (CN) 202310244910.3

(51) Int. Cl. C09K 5/06

(52) U.S. Cl. CPC C09K 5/063

(57) ABSTRACT

The present disclosure provides a use of a rare earth borate in a magnetic refrigeration material, wherein the rare earth borate is EuB₂O₄, Eu₂B₂O₅, or EuB₄O₇. A phase transition temperature of the rare earth borate of the present disclosure is less than 2 K. When a temperature is 1.3 K and a magnetic field change is in a range of from 0 to 1 T, a maximum magnetic entropy change of the EuB₂O₄ is ≤19.4 J·kg⁻¹·K⁻¹, and a maximum magnetic entropy change of the EuB₄O₇ is ≤21.2 J·kg⁻¹·K⁻¹; and when the temperature is 2.6 K and the magnetic field change is in a range of from 0 to 1 T, a maximum magnetic entropy change of the Eu₂B₂O₅ is ≤13.7 J·kg⁻¹·K⁻¹. The rare earth borate of the present disclosure is a low-temperature magnetic refrigeration material with excellent performance.

### CROSS-REFERENCE TO RELATED APPLICATIONS

The present application is a continuation-in-part application of PCT application No. PCT/CN2024/070517 filed on Jan. 4, 2024, which claims the benefit of Chinese Patent Application No. 202310244910.3 filed on Mar. 14, 2023. The contents of all of the aforementioned applications are incorporated by reference herein in their entirety.

### TECHNICAL FIELD

The present disclosure relates to the technical field of magnetic refrigeration materials, and particularly, it relates to a use of a rare earth borate in magnetic refrigeration materials and a preparation method of the rare earth borate.

### BACKGROUND

Magnetic refrigeration is a new technology that achieves refrigeration by using magneto-caloric effect of magnetic materials. Compared with traditional refrigeration technologies, magnetic refrigeration has the following advantages. (1) Green and environmentally friendly. Magnetic refrigeration uses solid-state refrigerants to avoid use of gases which are toxic, harmful, easily leaked, or flammable, such as freon, thereby protecting the ozone layer from damages and avoiding the occurrence of greenhouse effect or any other problems. (2) Energy-saving and efficient. Since the thermodynamic process of producing magneto-caloric effect by magnetic refrigeration is highly reversible, its intrinsic thermodynamic efficiency can reach Carnot cycle efficiency in theory, and its actual efficiency can be up to 60%-70% of the Carnot cycle efficiency. (3) Stable and reliable. A gas compressor is not necessary, and magnetic refrigeration has advantages of a low vibration, a low noise, a long life, and high reliability.

A core problem for magnetic refrigeration is the orderly change in magnetic moments of materials. Thus, the key for developing magnetic refrigeration is to study the magneto-caloric effect of materials and to explore and optimize materials for magnetic refrigeration. Since low-temperature refrigeration technology has important application value in the field of space science and in the liquefaction technology of helium and hydrogen, researches on low-temperature magnetic refrigeration materials are becoming more and more extensive. In recent years, rare earth metal oxides have become a new research hotspot in the field of magnetic refrigeration materials due to their advantages, such as, simple preparation processes, stable chemical properties, large-scale productions, easy molding and processing and low costs. However, the rare earth metal oxide materials have smaller magneto-caloric effect than those of alloy materials. Therefore, to explore material systems with large magneto-caloric effect and clarify the related physical problems is one of the directions that scientists are striving for at the moment.

Magnetic refrigeration materials with excellent performance must have a large magnetic entropy change, which requires the magnetic molecules to have a large spin ground state, a small magnetic anisotropy, a high magnetic density, an appropriate magnetic exchange and a low-lying excited spin state (Reference: Evangelisti M, Roubeau O, Palacios E, et al. Cryogenic Magnetocaloric Effect in a Ferromagnetic Molecular Dimer[J]. Angewandte Chemie International Edition, 2011.). In addition, high-spin metal complexes, as molecular magnets, have shown larger magneto-caloric effect values (MCE values) than rare earth alloys and magnetic nanoparticles, especially in an ultra-low temperature region, because the complexes have a long-range order and a weak intermolecular interaction, which avoid the reduction of magnetic entropy change (Sibille R, Mazet T, Malaman B, et al. A metal-organic framework as attractive cryogenic magnetorefrigerant. [J]. Chemistry, 2012, 18(41):12970-12973.). Therefore, it is urgent to develop a magnetic refrigeration material with a high magnetic entropy change in an ultra-low temperature region.

### SUMMARY OF THE DISCLOSURE

An objective of the present disclosure is to overcome the shortcomings in the prior art and provide a rare earth borate, which is suitable for low field and low temperature applications and has an excellent magnetic refrigeration performance, and a preparation method thereof.

In order to achieve the above objective, the present disclosure provides the following technical solutions.

In a first aspect, the present disclosure provides a use of a rare earth borate in a magnetic refrigeration material, wherein the rare earth borate is at least one selected from the group consisting of EuB₂O₄, Eu₂B₂O₅, and EuB₄O₇.

The inventors of the present disclosure have found that, among rare earth borates, EuB₂O₄, Eu₂B₂O₅ and EuB₄O₇ have a large magnetic entropy change and a high refrigeration capacity, and can be used to prepare a low-temperature magnetic refrigeration material. The use of the rare earth borates helps to promote the practical development of magnetic refrigeration as a green, energy-saving and environmentally friendly technology, and shows great scientific value and strategic significance for the construction of low-temperature research platforms, especially ultra-low-temperature research platforms, and for the low-temperature applications in the aerospace field.

As a preferred embodiment of the use of the present disclosure, the EuB₂O₄ crystallizes in space group Pnca with lattice constants: a=6.5836 Å, b=12.0433 Å, and c=4.339 Å; the Eu₂B₂O₅ crystallizes in space group P21/c with lattice constants: a=7.7767 Å, b=5.3529 Å, c=11.9006 Å, and β=92.8078°; and the EuB₄O₇ crystallizes in space group Pmn21 with lattice constants: a=4.435 Å, b=10.731 Å, and c=4.240 Å.

The inventors of the present disclosure have found that the rare earth borates of the present disclosure are single-phase polycrystalline materials, and the EuB₂O₄ crystallizes in space group Pnca, the Eu₂B₂O₅ crystallizes in space group P21/c, and the EuB₄O₇ crystallizes in space group Pmn21. The above three rare earth borates possess a large magnetic entropy change and an excellent magnetic refrigeration capacity at a low temperature in a low field, by combining metaborate ions having a small molecular weight with Eu²⁺ ions having a large magnetic moment.

As a preferred embodiment of the use of the present disclosure, a phase transition temperature of the rare earth borate is <2 K.

The inventors of the present disclosure have found that, when the phase transition temperature of the rare earth borate of the present disclosure is <2 K, the rare earth borate can be well applied to the preparation of low-temperature magnetic refrigeration materials.

As a preferred embodiment of the use of the present disclosure, when a temperature is 1.3 K and a magnetic field change is in a range of from 0 to 1 T, a maximum magnetic entropy change of the EuB₂O₄ is ≤19.4 J·kg⁻¹·K⁻¹, and a maximum magnetic entropy change of the EuB₄O₇ is ≤21.2 J·kg⁻¹·K⁻¹.

The inventors of the present disclosure have found that, when the temperature is 1.3 K and the magnetic field change is in a range of from 0 to 1 T, the maximum magnetic entropy change of the EuB₄O₇ is ≤21.2 J·kg⁻¹·K⁻¹ and the maximum magnetic entropy change of the EuB₂O₄ is ≤19.4 J·kg⁻¹·K⁻¹, thus the rare earth borate of the present disclosure has a better magnetocaloric property and exhibits a better magnetic refrigeration effect, compared with other low-temperature magnetic refrigeration materials (such as ErRu₂Si₂, ErNiSi or EuHo₂O₄).

As a preferred embodiment of the rare earth borate of the present disclosure, when a temperature is 2.6 K and a magnetic field change is in a range of from 0 to 1 T, a maximum magnetic entropy change of the Eu₂B₂O₅ is ≤13.7 J·kg⁻¹·K⁻¹.

The inventors of the present disclosure have found that, when the temperature is 2.6 K and the magnetic field change is in a range of from 0 to 1 T, the maximum magnetic entropy change of the Eu₂B₂O₅ is ≤13.7 J·kg⁻¹·K⁻¹, and thus the rare earth borate of the present disclosure has an excellent magneto-caloric property and an outstanding magnetic refrigeration effect.

In addition, the inventors of the present disclosure have found that, compared with the rare earth borates in other types in the prior art, for example, Eu₃B₂O₆ disclosed in Chinese patent CN115346744A as magnetic refrigeration materials, the specific rare earth borates of the present disclosure have more borate ligands in their chemical formulas and these borate ligands separate the europium atoms from each other, thus the distances between the europium atoms become larger, thereby reducing the interaction between the rare earth ions of the specific rare earth borates of the present disclosure. Thus, the phase transition temperatures of the specific rare earth borates of the present disclosure are significantly reduced, and the specific rare earth borates of the present disclosure, i.e., EuB₂O₄, Eu₂B₂O₅ and EuB₄O₇, can be used for efficient refrigeration in a lower temperature region (at about 2 K). In comparison, the phase transition temperature of Eu₃B₂O₆ is 8 K, thus the Eu₃B₂O₆ cannot be used for magnetic refrigeration at 2 K and below.

In a second aspect, the present disclosure also provides a method for preparing a rare earth borate, comprising the following steps:

S1, weighing a europium source, a boride and a first portion of a boron powder according to a stoichiometric ratio, then adding a second portion of the boron powder so that the boron powder is excessive, and mixing evenly to obtain a mixed powder;

S2, adding a solvent to the mixed powder obtained in step S1, and mixing evenly to obtain a slurry;

S3, subjecting the slurry obtained in step S2 to ball-milling and drying to obtain a precursor powder; and

S4, sintering the precursor powder obtained in step S3 to obtain the rare earth borate; wherein the rare earth borate is any one of EuB₂O₄, Eu₂B₂O₅, and EuB₄O₇.

The inventors of the present disclosure have found that, with the above-mentioned preparation method of the present disclosure, the excess boron powder added can compensate for boron loss caused by oxidation or volatilization of the boron source and ensure the purity of the product.

In addition, the preparation method of the rare earth borate of the present disclosure is simple, without any complex equipment adopted. Besides, the preparation method of the present disclosure has many advantages, such as energy-saving, safe, and environmentally friendly. When the rare earth borate of the present disclosure is applied in a magnetic refrigerator, higher refrigeration efficiency can be obtained. The use of the rare earth borate of the present disclosure helps to promote the practical development of magnetic refrigeration as a green, energy-saving and environmentally friendly technology, and shows great scientific value and strategic significance for the construction of low-temperature research platforms, especially ultra-low-temperature research platforms, and for the low-temperature applications in the aerospace field.

As a preferred embodiment of the preparation method of the present disclosure, in step S1, the rare earth borate is EuB₂O₄, and a molar ratio of the second portion of boron powder to the first portion of boron powder is (0.65-0.75):1; or the rare earth borate is Eu₂B₂O₅, and the molar ratio of the second portion of boron powder to the first portion of boron powder is (0.45-0.55): 1; or the rare earth borate is EuB₄O₇, and the molar ratio of the second portion of boron powder to the first portion of boron powder is (0.45-0.55):1.

The inventors of the present disclosure have done a large number of experimental studies on quantities of the boron powders, and found that in the reaction for preparing the rare earth borate by using the preparation method of the present disclosure, the boron powder can be used as a reducing agent to reduce trivalent europium in the europium oxide as a reactant into divalent europium. Besides, an excess boron powder can compensate for the boron loss caused by oxidation or volatilization of the boron source, thereby solving the problem of insufficient boron due to a fact that the boron powder will be partially oxidized by a small amount of oxygen remained in the furnace tube during the reaction and the boron powder will also be volatilized in a certain amount during the reaction. At the same time, since different target products have different reaction efficiencies and different sensitivities to oxygen, the excess boron powder within the above ranges will be beneficial for the reaction, when different rare earth borates are prepared. If the boron powder is insufficient, a part of trivalent europium cannot be reduced into divalent europium and a trivalent europium compound, which has a lower maximum magnetic entropy change at a low temperature in a low field, is generated, so that the magnetic refrigeration performance of the rare earth borate is decreased and the rare earth resource is wasted. An extreme excess of boron powder ensures that trivalent europium can be reduced into divalent europium, however, the extremely excess boron element will react with the target product to generate other divalent europium compounds (such as borides, europium (II) tetraborate), which are impurities and make the sample impure. Further, different compounds have different refrigeration temperature regions and different refrigeration performance, which will affect the magnetic refrigeration performance of the samples.

As a preferred embodiment of the preparation method of the present disclosure, in step S1, the europium source is Eu₂O₃.

As a preferred embodiment of the preparation method of the present disclosure, the boride is H₃BO₃ or B₂O₃.

As a preferred embodiment of the preparation method of the present disclosure, in step S1, the europium source and the boron source are both of analytical grade.

As a preferred embodiment of the preparation method of the present disclosure, in step S2, the solvent is water.

As a preferred embodiment of the preparation method of the present disclosure, in step S2, a mass ratio of the solvent to the mixed powder is (0.45-0.8):1.

As a preferred embodiment of the preparation method of the present disclosure, in step S4, the sintering is performed at a temperature ranging from 850° C. to 950° C., and a holding time for the sintering is 5 hours to 10 hours.

The inventors of the present disclosure have found that, when the above-mentioned process parameters of the present disclosure for sintering are adopted, the mass transfer process for materials is more efficient, and at the same time impurities can be prevented from generating, thereby obtaining a rare earth borate with a higher purity. In contrast, a shorter holding time for the sintering will lead to an incomplete reaction, thereby reducing the purity of the product. In addition, the wider temperature range for the sintering provided by the present disclosure can reduce the requirements for accuracy in the actual productions, which is beneficial for industrial productions.

As a preferred embodiment of the preparation method of the present disclosure, in step S4, a sintering furnace for the sintering is at least one selected from the group consisting of a muffle furnace, a tubular furnace, and an atmosphere furnace.

As a preferred embodiment of the preparation method of the present disclosure, a gas pressure for the sintering is normal pressure or vacuum.

As a preferred embodiment of the preparation method of the present disclosure, the sintering is performed in an atmosphere of nitrogen or in an atmosphere of argon.

Compared with the prior art, the present disclosure at least has the following beneficial effects.
(1) The phase transition temperatures of the rare earth borates of the present disclosure, i.e., EuB₂O₄, Eu₂B₂O₅ and EuB₄O₇, are all lower than 2 K. When the temperature is 1.3 K and the magnetic field change is in a range of from 0 to 1 T, the maximum magnetic entropy change of the EuB₄O₇ is ≤21.2 J·kg⁻¹·K⁻¹ and the maximum magnetic entropy change of the EuB₂O₄ is ≤19.4 J·kg⁻¹·K⁻1. When the temperature is 2.6 K and the magnetic field change is in a range of from 0 to 1 T, the maximum magnetic entropy change of the Eu₂B₂O₅ is ≤13.7 J·kg⁻¹·K⁻¹. Thus, the rare earth borates of the present disclosure are superior to the materials in the prior art and most low-temperature magnetic refrigeration materials (such as ErRu₂Si₂, ErNiSi or EuHo₂O₄), and they have a large magnetic entropy change and an excellent magnetic refrigeration capacity at a low temperature in a low field, and thus they are low-temperature magnetic refrigeration materials with excellent performance.
(2) The preparation method of the rare earth borates of the present disclosure has a simple process, without any complex equipment adopted. The preparation method of the present disclosure has many advantages, such as energy-saving, safe and environmentally friendly. When the rare earth borates of the present disclosure are applied in a magnetic refrigerator, higher refrigeration efficiency can be obtained. The use of the rare earth borates of the present disclosure helps to promote the practical development of magnetic refrigeration as a green, energy-saving and environmentally friendly technology, and shows great scientific value and strategic significance for the construction of low-temperature research platforms, especially ultra-low-temperature research platforms, and for the low-temperature applications in the aerospace field.

### BRIEF DESCRIPTION OF THE DRAWINGS

FIG. 1 shows the zero-field-cooled (ZFC) and field-cooled (FC) thermomagnetic curves of the rare earth borate in Example 1 of the present disclosure in a magnetic field of 0.01 T at a temperature ranging from 2 K to 30 K;

FIG. 2 shows the relationship between the magnetic entropy change of the rare earth borate in Example 1 of the present disclosure and the temperature for various magnetic field changes ranging from 0.2 T to 5 T;

FIG. 3 shows the zero-field-cooled (ZFC) and field-cooled (FC) thermomagnetic curves of the rare earth borate in Example 4 of the present disclosure in a magnetic field of 0.01 T at a temperature ranging from 2 K to 30 K;

FIG. 4 shows the relationship between the magnetic entropy change of the rare earth borate in Example 4 of the present disclosure and the temperature for various magnetic field changes ranging from 0.5 T to 5 T;

FIG. 5 shows the zero-field-cooled (ZFC) and field-cooled (FC) thermomagnetic curves of the rare earth borate in Example 5 of the present disclosure in a magnetic field of 0.01T at a temperature ranging from 0.4 K to 2.0 K;

FIG. 6 shows the relationship between the magnetic entropy change of the rare earth borate in Example 5 of the present disclosure and the temperature for various magnetic field changes ranging from 0.5 T to 5 T;

FIG. 7 shows the X-ray diffraction spectrums of the polycrystalline EuB₂O₄ prepared in Example 1, Example 2, Comparative Example 1 and Comparative Example 2 of the present disclosure;

FIG. 8 shows the X-ray diffraction spectrums of the polycrystalline EuB₂O₄ prepared in Example 3, Comparative Example 3 and Comparative Example 4 of the present disclosure;

FIG. 9 shows the X-ray diffraction spectrums of the polycrystalline EuB₂O₄ prepared in Example 3, Comparative Example 5 and Comparative Example 6 of the present disclosure;

FIG. 10 shows the X-ray diffraction spectrums of the polycrystalline Eu₂B₂O₅ prepared in Example 4, Comparative Example 7 and Comparative Example 8 of the present disclosure; and

FIG. 11 shows the X-ray diffraction spectrums of the polycrystalline EuB₄O₇ prepared in Example 5, Comparative Example 9 and Comparative Example 10 of the present disclosure.

### DETAILED DESCRIPTION

The technical solutions of the present disclosure are further illustrated below with reference to the examples and drawings. Obviously, the described examples are only parts, but not all of the examples of the present disclosure. Based on the examples in the present disclosure, all other examples obtained by those skilled in the art, without any creative work, are fallen within the scope of protection of the present disclosure. Unless otherwise specified, all methods or operations used in the examples are conventional methods or conventional operations in the field.

Eu₂O₃, H₃BO₃ and boron powder used in the examples and comparative examples of the present disclosure are all of analytical grade. The boron powder is a high-purity boron powder with a purity of 99.9% (metals basis) and a particle size (D₅₀) of 20 μm.

### EXAMPLE 1

A rare earth borate was provided in Example 1 of the present disclosure, and a chemical formula of the rare earth borate in Example 1 was EuB₂O₄.

The method for preparing the rare earth borate in Example 1 included the following steps:

S1, weighing Eu₂O₃, H₃BO₃ and a first portion of boron powder according to a stoichiometric ratio, then adding a second portion of boron powder, so that the boron powder was excessive, wherein a molar ratio of the second portion of boron powder to the first portion of boron powder was 0.7:1, and mixing evenly to obtain a mixed powder;

S2, adding water to the mixed powder obtained in step S1, and mixing evenly to obtain a slurry;

S3, subjecting the slurry obtained in step S2 to ball milling thoroughly by using a planetary ball mill, and then drying the slurry in an electric blast drying oven to obtain a precursor powder; and

S4, placing the precursor powder obtained in step S3 in a tube furnace, and sintering it in an atmosphere of argon at 950° C. for 10 hours to obtain the rare earth borate.

### EXAMPLE 2

A rare earth borate was provided in Example 2 of the present disclosure, and a chemical formula of the rare earth borate in Example 2 was EuB₂O₄.

The method for preparing the rare earth borate in Example 2 included the following steps:

S1, weighing Eu₂O₃, H₃BO₃ and a first portion of boron powder according to a stoichiometric ratio, then adding a second boron powder so that the boron powder was excessive, wherein a molar ratio of the second portion of boron powder to the first portion of boron powder was 0.8:1, and mixing evenly to obtain a mixed powder;

S2, adding water to the mixed powder obtained in step S1, and mixing evenly to obtain a slurry;

S3, subjecting the slurry obtained in step S2 to ball milling thoroughly by using a planetary ball mill, and then drying the slurry in an electric blast drying oven to obtain a precursor powder; and

S4, placing the precursor powder obtained in step S3 in a tube furnace, and sintering it in an atmosphere of argon at 900° C. for 10 hours to obtain the rare earth borate.

### EXAMPLE 3

A rare earth borate was provided in Example 3 of the present disclosure, and a chemical formula of the rare earth borate in Example 3 was EuB₂O₄.

The method for preparing the rare earth borate in Example 3 included the following steps:

S1, weighing Eu₂O₃, H₃BO₃ and a first portion of boron powder according to a stoichiometric ratio, then adding a second boron powder so that the boron powder was excessive, wherein a molar ratio of the second portion of boron powder to the first portion of boron powder was 0.7:1, and mixing evenly to obtain a mixed powder;

S2, adding water to the mixed powder obtained in step S1, and mixing evenly to obtain a slurry;

S3, subjecting the slurry obtained in step S2 to ball milling thoroughly by using a planetary ball mill, and then drying the slurry in an electric blast drying oven to obtain a precursor powder; and

S4, placing the precursor powder obtained in step S3 in a tube furnace, and sintering it in an atmosphere of argon at 850° C. for 10 hours to obtain the rare earth borate.

### EXAMPLE 4

A rare earth borate was provided in Example 4 of the present disclosure, and a chemical formula of the rare earth borate in Example 4 was Eu₂B₂O₅.

The method for preparing the rare earth borate in Example 4 included the following steps:

S1, weighing Eu₂O₃, H₃BO₃ and a first portion of boron powder according to a stoichiometric ratio, then adding a second boron powder so that the boron powder was excessive, wherein a molar ratio of the second portion of boron powder to the first portion of boron powder was 0.5:1, and mixing evenly to obtain a mixed powder;

S2, adding water to the mixed powder obtained in step S1, and mixing evenly to obtain a slurry;

S3, subjecting the slurry obtained in step S2 to ball milling thoroughly by using a planetary ball mill, and then drying the slurry in an electric blast drying oven to obtain a precursor powder; and

S4, placing the precursor powder obtained in step S3 in a tube furnace, and sintering it in an atmosphere of argon at 950° C. for 10 hours to obtain the rare earth borate.

### EXAMPLE 5

A rare earth borate was provided in Example 5 of the present disclosure, and a chemical formula of the rare earth borate in Example 5 was EuB₄O₇.

The method for preparing the rare earth borate in Example 5 included the following steps:

S1, weighing Eu₂O₃, H₃BO₃ and a first portion of boron powder according to a stoichiometric ratio, then adding a second boron powder so that the boron powder was excessive, wherein a molar ratio of the second portion of boron powder to the first portion of boron powder was 0.5:1, and mixing evenly to obtain a mixed powder;

S2, adding water to the mixed powder obtained in step S1, and mixing evenly to obtain a slurry;

S3, subjecting the slurry obtained in step S2 to ball milling thoroughly by using a planetary ball mill, and then drying the slurry in an electric blast drying oven to obtain precursor powder; and

S4, placing the precursor powder obtained in step S3 in a tube furnace, and sintering it in an atmosphere of argon at 950° C. for 10 hours to obtain the rare earth borate.

### Comparative Example 1

A rare earth borate was provided in Comparative Example 1 of the present disclosure, a chemical formula of the rare earth borate in Comparative Example 1 was EuB₂O₄.

The difference between the preparation method of the rare earth borate in Comparative Example 1 and that in Example 1 was that, in step S1, the molar ratio of the second portion of boron powder to the first portion of boron powder was 0.6:1. Other steps of the preparation method of the rare earth borate in this comparative example were the same as those in Example 1.

### Comparative Example 2

A rare earth borate was provided in Comparative Example 2 of the present disclosure, a chemical formula of the rare earth borate in Comparative Example 2 was EuB₂O₄.

The difference between the preparation method of the rare earth borate in Comparative Example 2 and that in Example 1 was that, in step S1, the molar ratio of the second portion of boron powder to the first portion of boron powder was 0.9:1. Other steps of the preparation method of the rare earth borate in this comparative example were the same as those in Example 1.

### Comparative Example 3

A rare earth borate was provided in Comparative Example 3 of the present disclosure, a chemical formula of the rare earth borate in Comparative Example 3 was EuB₂O₄.

The difference between the preparation method of the rare earth borate in Comparative Example 3 and that in Example 1 was that, in step S3, the temperature for sintering was 800° C. Other steps of the preparation method of the rare earth borate in this comparative example were the same as those in Example 1.

### Comparative Example 4

A rare earth borate was provided in Comparative Example 4 of the present disclosure, a chemical formula of the rare earth borate in Comparative Example 4 was EuB₂O₄.

The difference between the preparation method of the rare earth borate in Comparative Example 4 and that in Example 1 was that, in step S3, the temperature for sintering was 1,000° C. Other steps of the preparation method of the rare earth borate in this comparative example were the same as those in Example 1.

### Comparative Example 5

A rare earth borate was provided in Comparative Example 5 of the present disclosure, a chemical formula of the rare earth borate in Comparative Example 5 was EuB₂O₄.

The difference between the preparation method of the rare earth borate in Comparative Example 5 and that in Example 1 was that, in step S3, the holding time for the sintering was 2 hours. Other steps of the preparation method of the rare earth borate in Comparative Example 5 were the same as those in Example 1.

### Comparative Example 6

A rare earth borate was provided in Comparative Example 6 of the present disclosure, a chemical formula of the rare earth borate in Comparative Example 6 was EuB₂O₄.

The difference between the preparation method of the rare earth borate in Comparative Example 6 and that in Example 1 was that, in step S3, the holding time for the sintering was 3 hours. Other steps of the preparation method of the rare earth borate in Comparative Example 6 were the same as those in Example 1.

### Comparative Example 7

A rare earth borate was provided in Comparative Example 7 of the present disclosure, a chemical formula of the rare earth borate in Comparative Example 7 was Eu₂B₂O₅.

The difference between the preparation method of the rare earth borate in Comparative Example 7 and that in Example 4 was that, in step S1, the molar ratio of the second portion of boron powder to the first portion of boron powder was 0.4:1. Other steps of the preparation method of the rare earth borate in Comparative Example 7 were the same as those in Example 4.

### Comparative Example 8

A rare earth borate was provided in Comparative Example 8 of the present disclosure, a chemical formula of the rare earth borate in Comparative Example 7 was Eu₂B₂O₅.

The difference between the preparation method of the rare earth borate in Comparative Example 8 and that in Example 4 was that, in step S1, the molar ratio of the second portion of boron powder to the first portion of boron powder was 0.6:1. Other steps of the preparation method of the rare earth borate in Comparative Example 8 were the same as those in Example 4.

### Comparative Example 9

A rare earth borate was provided in Comparative Example 9 of the present disclosure, a chemical formula of the rare earth borate in Comparative Example 9 was EuB₄O₇.

The difference between the preparation method of the rare earth borate in Comparative Example 9 and that in Example 5 was that, in step S1, the molar ratio of the second portion of boron powder to the first portion of boron powder was 0.4:1. Other steps of the preparation method of the rare earth borate in Comparative Example 9 were the same as those in Example 5.

### Comparative Example 10

A rare earth borate was provided in Comparative Example 10 of the present disclosure, a chemical formula of the rare earth borate in Comparative Example 10 was EuB₄O₇.

The difference between the preparation method of the rare earth borate in Comparative Example 10 and that in Example 5 was that, in step S1, the molar ratio of the second portion of boron powder to the first portion of boron powder was 0.6:1. Other steps of the preparation method of the rare earth borate in Comparative Example 10 were the same as those in Example 5.

### Effect Example 1

The rare earth borates prepared in Example 1, Example 4, and Example 5 were subjected to magnetic testing and analysis. The specific testing method was shown as following: The Physical Property Measurement System (PPMS), which was manufactured by Quantum Design Inc., US and equipped with a vibrating sample magnetometer (VSM), was adopted for testing; a sample was placed on a vibratory sample rod, and a varied magnetic flux was generated in a gold-plated detection coil in the system; and the magnetic data of the sample can be measured, through an induced electromotive force generated by the magnetic flux.

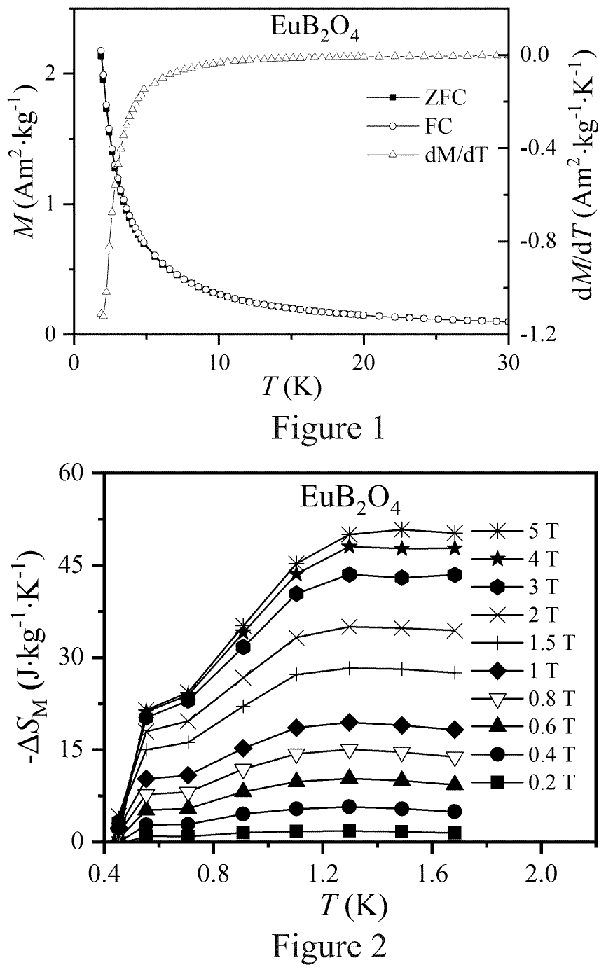

The testing results were shown in FIGS. 1 to 6.

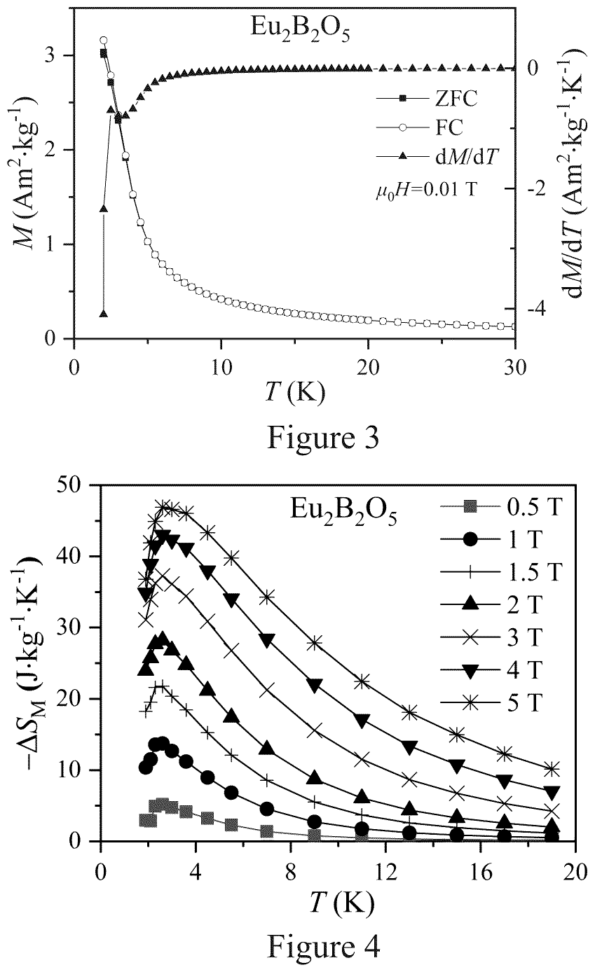

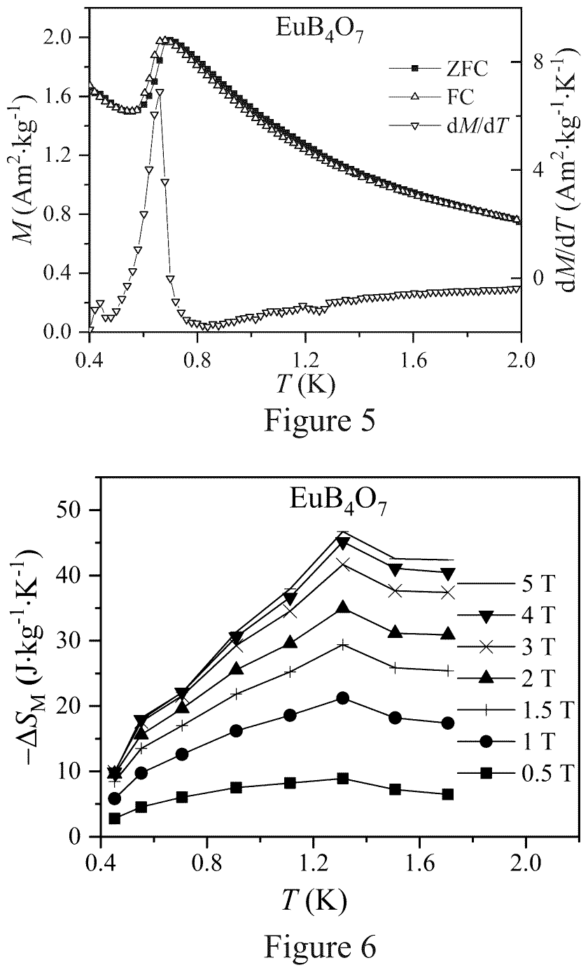

FIG. 1 shows the zero-field-cooled (ZFC) and field-cooled (FC) thermomagnetic curves of the rare earth borate in Example 1 of the present disclosure in a magnetic field of 0.01 T at a temperature ranging from 2 K to 30 K; FIG. 3 shows the zero-field-cooled (ZFC) and field-cooled (FC) thermomagnetic curves of the rare earth borate in Example 4 of the present disclosure in a magnetic field of 0.01 T at a temperature ranging from 2 K to 30 K; and FIG. 5 shows the zero-field-cooled (ZFC) and field-cooled (FC) thermomagnetic curves of the rare earth borate in Example 5 of the present disclosure in a magnetic field of 0.01T at a temperature ranging from 0.4 K to 2.0 K. As can be seen from FIGS. 1, 3 and 5, a peak at around 2 K is appeared in the derivative curves of the ZFC thermomagnetic curves of the rare earth borates prepared in Example 1, Example 4 and Example 5, indicating that the phase transition temperatures of the EuB₂O₄, Eu₂B₂O₅ and EuB₄O₇ in the present disclosure are all around 2 K, and the EuB₂O₄, Eu₂B₂O₅ and EuB₄O₇ are all magnetic refrigeration materials that can be used in a low-temperature region. In addition, the ZFC and FC thermomagnetic curves of the rare earth borates prepared in Example 1, Example 4 and Example 5 are completely overlapped, indicating that the magnetic phase transition processes are highly reversible, without any thermal hysteresis.

By using the Maxwell's relations, the magnetic entropy changes for various magnetic field changes can be calculated, according to the isothermal magnetization curves at different temperatures.

FIG. 2 shows the relationship between the magnetic entropy change of the rare earth borate in Example 1 of the present disclosure and the temperature for various magnetic field changes ranging from 0.2 T to 5 T. It can be seen from the figure that −ΔSₘ increases monotonically with the increase of the magnetic field changes applied. When the temperature is around 1.3 K and the magnetic field change is in a range of from 0 to 1 T, the maximum magnetic entropy change of the rare earth borate, EuB₂O₄, in Example 1 is 19.4 J·kg⁻¹·K⁻¹.

FIG. 4 shows the relationship between the magnetic entropy change of the rare earth borate in Example 4 of the present disclosure and the temperature for various magnetic field changes ranging from 0.5 T to 5 T. It can be seen from the figure that, when the magnetic field change is in a range of from 0 to 1T and the temperature is around 2.3 K, the maximum magnetic entropy change of the rare earth borate, Eu₂B₂O₅, in Example 4 is 13.7 J·kg⁻¹·K⁻¹.

FIG. 6 shows the relationship between the magnetic entropy change of the rare earth borate in Example 5 of the present disclosure and the temperature for various magnetic field changes ranging from 0.5 T to 5 T. It can be seen from the figure that, when the magnetic field change is in a range of from 0 to 1 T and the temperature is around 1.3 K, the maximum magnetic entropy change of the rare earth borate, EuB₄O₇, in Example 5 is 21.2 J·kg⁻¹·K⁻¹.

In summary, the magneto-caloric effects of the magnetic refrigeration materials, i.e., the rare earth borates, EuB₂O₄, Eu₂B₂O₅, and EuB₄O₇, prepared in the present disclosure are much larger than those of many materials with great potential (such as Eu₃B₂O₆, ErRu₂Si₂, ErNiSi, EuHo₂O₄), and these rare earth borates show very excellent magneto-caloric performance at a low temperature in a low field. When these rare earth borates are applied in magnetic refrigeration systems, the refrigeration efficiency can be greatly improved.

### Effect Example 2

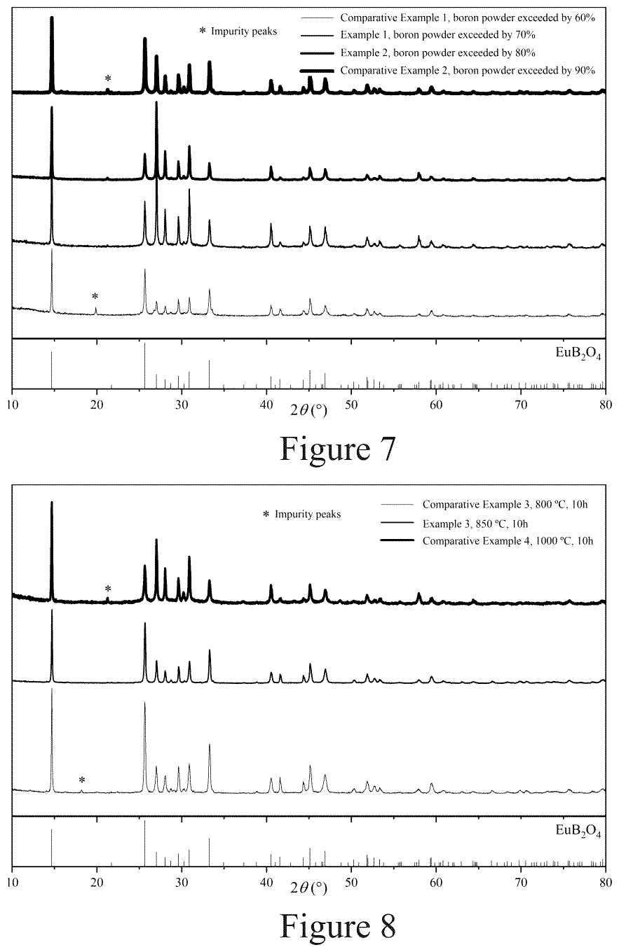

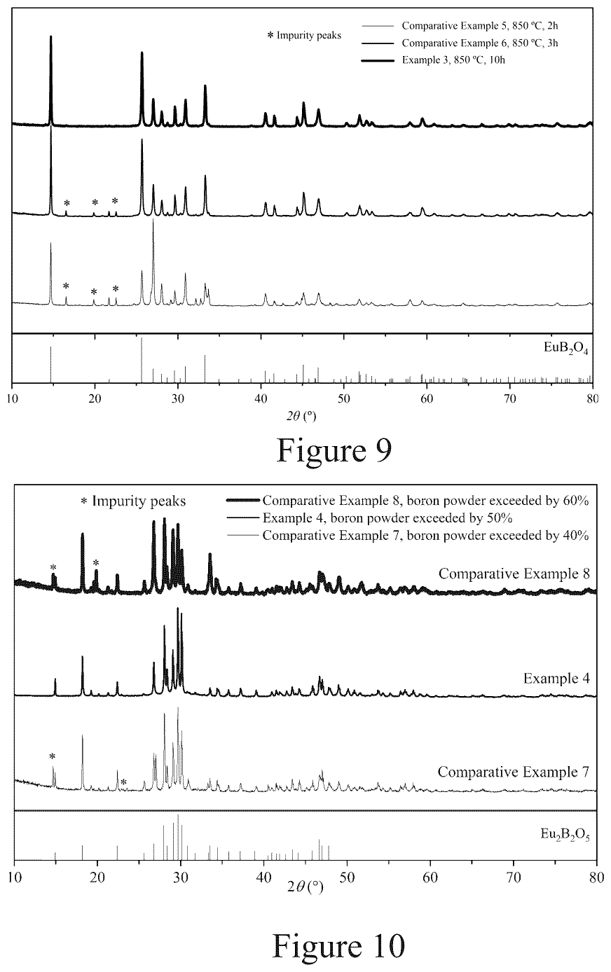

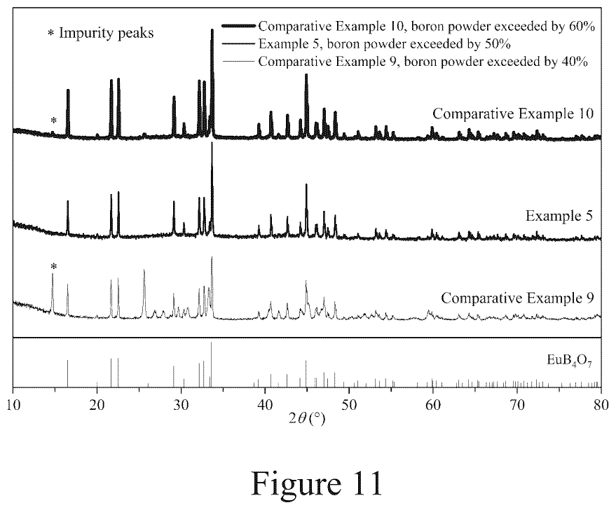

The rare earth borates prepared in Examples 1-5 and Comparative Examples 1-10 of the present disclosure were subjected to an X-ray powder diffraction phase analysis, and the test results were shown in FIGS. 7-11. FIG. 7 shows the X-ray diffraction spectrums of the polycrystalline EuB₂O₄ prepared in Example 1, Example 2, Comparative Example 1 and Comparative Example 2 of the present disclosure; FIG. 8 shows the X-ray diffraction spectrums of the polycrystalline EuB₂O₄ prepared in Example 3, Comparative Example 3 and Comparative Example 4 of the present disclosure; FIG. 9 shows the X-ray diffraction spectrums of the polycrystalline EuB₂O₄ prepared in Example 3, Comparative Example 5 and Comparative Example 6 of the present disclosure; FIG. 10 shows the X-ray diffraction spectrums of the polycrystalline Eu₂B₂O₅ prepared in Example 4, Comparative Example 7 and Comparative Example 8 of the present disclosure; and FIG. 11 shows the X-ray diffraction spectrums of the polycrystalline EuB₄O₇ prepared in Example 5, Comparative Example 9 and Comparative Example 10 of the present disclosure.

It can be seen from FIG. 7 and FIG. 10 that, when the second portion of boron powder added is insufficient or much excessive, the peaks of trivalent europium compounds and europium (II) tetraborate are appeared, respectively, indicating that the obtained rare earth borate crystal is not pure. As can be seen from FIG. 11, when the second portion of boron powder added is insufficient, an impurity peak for europium (II) metaborate is appeared, indicating that the obtained rare earth borate crystal is not pure and the purity of the product is decreased. As can be seen from FIG. 8, when a lower temperature is adopted for the sintering, the peaks of trivalent europium compounds, which are generated due to complete reactions, are appeared; when a higher temperature is adopted for the sintering, the peaks of borides, which are generated due to a reaction between the melted sample and the boron powder, are appeared. These impurity peaks all indicate that the obtained rare earth borate crystals are not pure and the purity of the products is decreased. As can be seen from FIG. 9, when the holding time for the sintering is short, impurity peaks are appeared due to incomplete reactions, thus the purity of the product is decreased.

In addition, it can be seen from FIGS. 7-11 that, a high-purity rare earth borate can be prepared in the present disclosure, by controlling the quantity of the second portion of boron powder added within a specific range and sintering at a temperature ranging from 850° C. to 950° C. for 5 to 10 hours. Besides, the wider temperature range of the present disclosure reduces the requirements for accuracy in actual production process, which is suitable for industrial production.

In summary, in the present disclosure, by combining metaborate ions having a small molecular weight with Eu²⁺ ions having a large magnetic moment, three novel low-temperature magnetic refrigeration materials, i.e., three rare earth borates, which have a large low-field magneto-caloric effect at a low temperature and have great application prospects in the field of low-temperature magnetic refrigeration technology, are prepared.

Finally, it should be noted that the above examples are only intended to illustrate the technical solutions of the present disclosure, rather than to limit the protection scope of the present disclosure. Although the present disclosure has been illustrated in detail with reference to preferred examples, those skilled in the art should understand that the technical solutions of the present disclosure can be modified or equivalently replaced, without departing from the essence and scope of the technical solutions of the present disclosure.

1. A method for preparing a rare earth borate as a magnetic refrigeration material, wherein the rare earth borate is EuB₂O₄, Eu₂B₂O₅, or EuB₄O₇;
wherein a phase transition temperature of the rare earth borate is <2 K; when a temperature is 1.3 K and a magnetic field change is in a range of from 0 to 1 T, a maximum magnetic entropy change of the EuB₂O₄ is ≤19.4 J·kg⁻¹·K⁻¹, and a maximum magnetic entropy change of the EuB₄O₇ is ≤21.2 J·kg⁻¹·K⁻¹; or, when a temperature is 2.6 K and a magnetic field change is in a range of from 0 to 1 T, a maximum magnetic entropy change of the Eu₂B₂O₅ is ≤13.7 J·kg⁻¹·K⁻¹;
wherein the method comprises following steps:
S1, weighing and mixing a europium source, a boride and a first portion of a boron powder according to a stoichiometric ratio, then adding a second portion of the boron powder to a resulting mixture so that the boron powder is excessive, and mixing evenly to obtain a mixed powder;
S2, adding a solvent to the mixed powder obtained in step S1, and mixing evenly to obtain a slurry;
S3, subjecting the slurry obtained in step S2 to ball-milling and drying to obtain a precursor powder; and
S4, sintering the precursor powder obtained in step S3 to obtain the rare earth borate;
wherein in step S1, the rare earth borate is EuB₂O₄, and a molar ratio of the second portion of boron powder to the first portion of boron powder is (0.65-0.75):1; or the rare earth borate is Eu₂B₂O₅, and the molar ratio of the second portion of boron powder to the first portion of boron powder is (0.45-0.55):1; or the rare earth borate is EuB₄O₇, and the molar ratio of the second portion of boron powder to the first portion of boron powder is (0.45-0.55):1;
wherein in step S4, the sintering is performed at a temperature ranging from 850° C. to 950 ° C., and a holding time of the sintering is 5 hours to 10 hours.

2. The method of claim 1, wherein the EuB₂O₄ crystallizes in space group Pnca with lattice constants: a=6.5836 Å, b=12.0433 Å, and c=4.339 Å; the Eu₂B₂O₅ crystallizes in space group P21/c with lattice constants: a=7.7767 Å, b=5.3529 Å, c=11.9006 Å, and β=92.8078°; and the EuB₄O₇ crystallizes in space group Pmn21 with lattice constants: a=4.435 Å, b=10.731 Å, and c=4.240 Å.

3. The method of claim 1, wherein in step S1, the europium source is Eu₂O₃.

4. The method of claim 1, wherein the boride is H₃BO₃ or B₂O₃.
